(19) United States
(12) Patent Application Publication
(10) Pub. No.: US 2019/0002630 A1
(43) Pub. Date: Jan. 3, 2019

(54) FERULIC ACID AND P-COUMARIC ACID BASED POLYMERS AND COPOLYMERS

(71) Applicant: University of Florida Research Foundation, Inc., Gainesville, FL (US)

(72) Inventors: Ha Thi Hoang NGUYEN, Gainesville, FL (US); Stephen A. MILLER, Gainesville, FL (US)

(21) Appl. No.: 16/069,409

(22) PCT Filed: Jan. 11, 2017
(86) PCT No.: PCT/US2017/012938

§ 371 Date: Jul. 11, 2018

Related U.S. Application Data
(60) Provisional application No. 62/277,207, filed on Jan. 11, 2016.

(51) Int. Cl. C08G 63/06; C08G 63/664; C08G 63/86

(52) U.S. Cl. CPC C08G 63/06; C08G 63/866; C08G 63/664

(57) ABSTRACT

A cinnamic acid polymer or copolymer that can be employed as a biorenewable alternative to a commodity polymer results from the polymerization of hydroxyalkyldihydroferulic acids, hydroxyalkylferulic acids, hydroxyalkyldihydrocoumaric acids, hydroxyalkylcoumaric acids, dihydroferulic acid, ferulic acid, dihydrocoumaric acid, and coumaric acid in various proportions. The physical properties of the plastic are controlled by the composition of the polymers. A melt polycondensation route achieves the desired plastics.

### CROSS-REFERENCE TO A RELATED APPLICATION

This application claims the benefit of U.S. Provisional Application Ser. No. 62/277,207, filed Jan. 11, 2016, the disclosure of which is hereby incorporated by reference in its entirety, including all figures, tables and drawings.

This invention was made with government support under CHE-1305794 awarded by the National Science Foundation. The government has certain rights in the invention.

### BACKGROUND OF INVENTION

Poly(aromatics), for example, polystyrene (PS), are highly used as commodity plastics. PS alone accounts for about 9% of the global plastic market. PS is wholly derived from non-renewable fossil fuels. Despite its broad utility in packaging, unreacted styrene monomer can remain in the polymer and is continually released throughout the PS life cycle. This situation is potentially calamitous because styrene has been reported as a hazardous air pollutant and a human carcinogen. PS is neither biorenewable nor biodegradable and remains in the environment long after its use. Although polystyrene is recycled in some regions, Europe in particular, most PS is either added to landfills or directly discarded into the environment, often concentrating in rivers and oceans.

The development of new polymeric materials from renewable resources is gaining considerable attention. Biorenewability is directed toward a sustainable raw material supply where the raw material is renewed from plants or other biological matter, generally through agricultural. Biorenewable polymers are pursued as environmentally friendly replacements for commodity plastics from petrochemical starting materials. The goal is to use low cost readily available starting materials from biorenewable resources such that biorenewable polymers can be competitive with current commercial plastics in the marketplace.

Creating a biorenewable polymer directly from a crop with the limitations imposed by nature with respect to processing and properties, a practical goal is to develop polymers that include monomers derived from biorenewable sources that are chemically identical to or a mimic of those derived from petroleum sources. Thermoplastic biorenewable polymers are potentially recyclable, which is advantageous for consumer packaging and other high volume needs. A commercially important thermoplastic or its mimic that is prepared by a step-growth process is a particularly practical target for biorenewable monomers.

The optimal source for renewable aromatics is lignin, which makes up about 30% of biomass and is the second most abundant organic polymer on earth. Ferulic acid (FA) and p-coumaric acid (CA) are the two most abundant hydroxycinnamic acids in the plant kingdom and these can be sourced from lignin. Excellent sources are from the lignocellulose of megacrops sugarcane and corn. Not only are these aromatic acids abundantly available from non-food agricultural waste (bagasse, stover), they possess antioxidant properties which protect against oxidative stress in cells and the progression of age-related diseases, as well as reduce the risk of some types of cancer. Present to some degree in virtually all plants, these hydroxycinnamic acids are especially abundant in “superfoods.”

The synthesis of polydihydroferulic acid (PHFA) and poly(dihydroferulic acid-co-ferulic acid), allowed production of a biorenewable polyethylene terephthalate (PET) mimic and has been taught in Mialon et al. U.S. Pat. No. 9,080,011. Polyferulic acid (PFA) is an insoluble, intractable material with a melting temperature (Tm) of 325° C. and a glass transition temperature (Tg) of 150° C. In contrast, its hydrogenated analogue, PHFA, displays a melting temperature of 234° C. and a T_{g} of 73° C. that allows it to compete with that of PET, which displays a T_{g} of 67° C.

Sasiwilaskorn et al. J. Appl. Polym. Sci., 2008, 109, 3502-10 explored the synthesis of polyethylene coumarate (PEC) homopolymer using N,N-dicyclohexylcarbodiimide (DCC) as a coupling agent. The polymer was impure with no reported thermal properties or molecular weight characterization. Satomura, U.S. Pat. No. 4,053,415 discloses hydroxyethylcoumaric methylester and its use in photocrosslinkable polymers. Makoto et al. European Patent No. 0883016 discloses polypropylene ferulate but thermal properties and molecular weights are not given. Kreye et al. Macromol. Chem. Phys., 2013, 214, 1452-64 disclosed the polycondensation of hydroxyethyldihydroferulic methylester to form polyethylene dihydroferulate using triazabicyclodecene (TBD) as an organo-catalyst but with poor results that the Mₙ was only 5,440 and a T_{g} of −27° C.

The development of biorenewable polymers copolymers that are derived from lignin with physical properties to displace commodity plastics remains a desired goal.

### BRIEF SUMMARY

Embodiments of the invention are directed to cinnamic acid polymers or copolymers, comprising the structure:

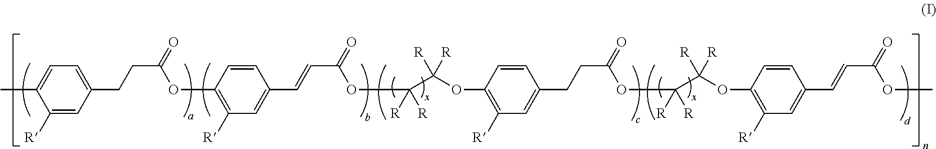

wherein R′ is H, OCH₃, or a mixture thereof; where —(CR₂)ₓCR₂— is C₂ to C₁₂, R is independently H or C₁ to C₈ alkyl, x is independently 1 to 11, a≥0, b≥0, c≥0, d≥0, n(a+b+c+d)≥40 and wherein: when a>0 either c+d>0 or R′=a combination of H and OCH₃; when b>0 either c+d>0 or R′=a combination of H and OCH₃; when c>0 either a+b+d>0, R′=H or a combination of H and OCH₃, or —(CR₂)ₓCR₂— is C₃ to C₁₂ alkylene; or when d>0, a+b+c>0.

In an embodiment of the invention, cinnamic acid copolymers are formed from a polymerization mixture of at least two monomers selected from

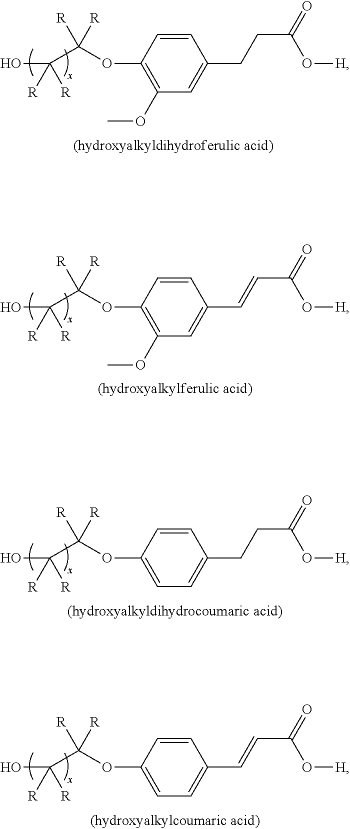

a metal oxide, metal alkoxide, or metal acetate catalyst that is heated to a temperature above the glass transition temperature of the copolymer with removal of water from the polymerization mixture.

In an embodiment of the invention, cinnamic acid copolymers are formed from a polymerization mixture of at least two monomers selected from acetyl dihydroferulic acid, acetyl ferulic acid), acetyl dihydrocoumaric acid, and acetyl coumaric acid, where when acetyl dihydroferulic acid is a first monomer, a second monomer is acetyl dihydrocoumaric acid or acetyl coumaric acid and when acetyl dihydrocoumaric acid is a first monomer, a second monomer is acetyl-dihydroferulic acid or acetyl ferulic acid), a metal oxide, metal alkoxide, or metal acetate catalyst, that is heated to a temperature above the glass transition temperature of the copolymer with removal of acetic acid from the polymerization mixture

### BRIEF DESCRIPTION OF DRAWINGS

FIG. 1 shows a composite plot of glass transition temperatures observed for poly(hydroxyethyldihydroferulic acid-co-hydroxyethylferulic acid) (R=OMe, diamonds) and poly(hydroxyethyldihydrocoumaric acid-co-hydroxyethylcoumaric acid) (R=H, squares).

FIG. 2 is a reaction scheme for the preparation of the ferulic acid and p-coumaric acid based polymers and copolymers, according to an embodiment of the invention.

FIG. 3 is a reaction scheme for the preparation of the acetylferulic acid, acetyl-p-coumaric acid, acetyldihydroferulic acid, and acetyl-dihydro-p-coumaric acid.

FIG. 4 is a reaction scheme for the preparation of the ferulic acid and p-coumaric acid based copolymers via condensation with the loss of acetic acid, according to an embodiment of the invention

FIG. 5 shows a composite plot of glass transition temperatures observed for poly(ferulic acid-co-coumaric acid), poly(dihydrocoumaric acid-co-coumaric acid), poly(dihydroferulic acid-co-ferulic acid), poly(ferulic acid-co-dihydrocoumaric acid), poly(dihydroferulic acid-co-coumaric acid), and poly(dihydroferulic acid-co-dihydrocoumaric acid).

### DETAILED DISCLOSURE

Embodiments of the invention are directed to homopolymers and copolymers that include repeating units derived from p-coumaric acid and/or ferulic acid. In embodiments of the invention, polymers have molecular weights in excess of 10,000 and glass transition temperatures in excess of 50° C. In embodiments of the invention, repeating units that are present in the copolymer include p-coumaric acid and/or ferulic acid. In embodiments of the invention repeating units that are present in the copolymer include those derived from dihydro-p-coumaric acid and/or dihydroferulic acid. In embodiments of the invention repeating units that are present in the copolymer include those derived from hydroxyalkyl-p-coumaric acid and/or hydroxyalkylferulic acid. In embodiments of the invention repeating units that are present in the copolymer include those derived from hydroxyalkyldihydro-p-coumaric acid and/or hydroxyalkyldihydroferulic acid, where the alkyl group can be a C₂ to C₁₀ linear or branched alkyl groups where there are at least two carbons between oxygen atoms. Copolymers can include a mixture of repeating units with different alkyl groups of the same aromatic portion of the repeating units.

The polymers and copolymers according to embodiments of the invention have the structure:

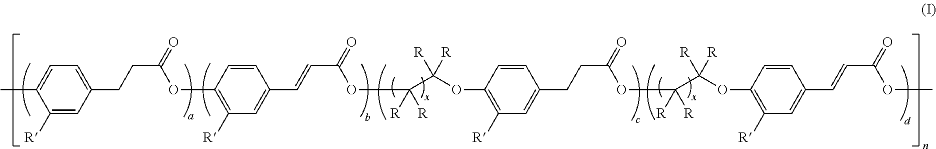

where: R′ is H, OCH₃, or a mixture thereof; where —(CR₂)ₓCR₂— is C₂ to C₁₂, R is independently H or C₁ to C₈ alkyl, and x is independently 1 to 11; a≥0, b≥0, c≥0, d≥0, and n(a+b+c+d)≥40; wherein: when a>0 either c+d>0 or R′=a combination of H and OCH₃; when b>0 either c+d>0 or R′=a combination of H and OCH₃; when c>0 either a+b+d>0, R′=H or a combination of H and OCH₃, or —(CR₂)ₓCR₂— is C₃ to C₁₂ alkylene; or when d>0, a+b+c>0.

In an embodiment of the invention, the polymer has the structure:

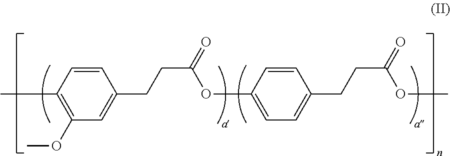

where a′>0, a″>0, and n(a′+a″)≥40.

In an embodiment of the invention, the polymer has the structure:

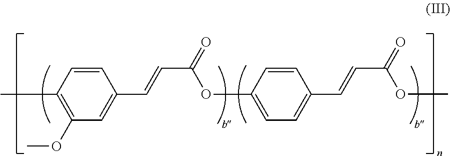

where b′>0, b″>0, and n(b′+b″)≥40.

In an embodiment of the invention, the polymer has the structure:

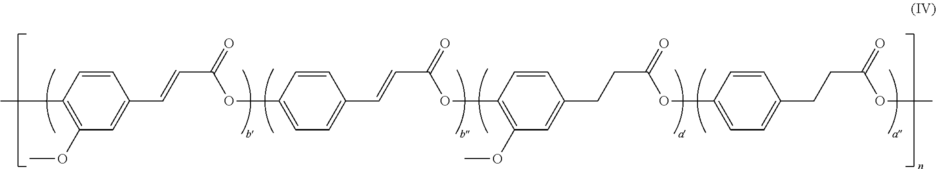

where a′>0, a″>0, b′>0, b″>0, and n(a′+a″+b′+b″)≥40.

In an embodiment of the invention, the polymer has the structure:

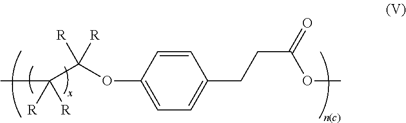

where n(c)≥40.

In an embodiment of the invention, the polymer has the structure:

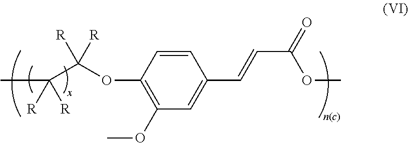

where n(c)≥40 and —(CR₂)ₓCR₂— is C₃ to C₁₂ alkylene.

In an embodiment of the invention, the polymer has the structure:

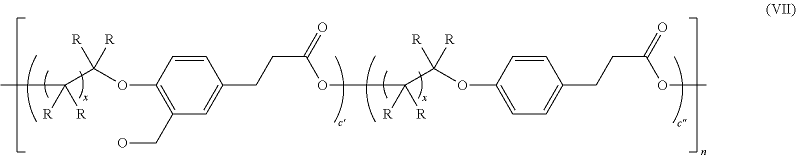

where c′>0, c″>0, and n(c′+c″)≥40.

In an embodiment of the invention, the polymer has any of the structures:

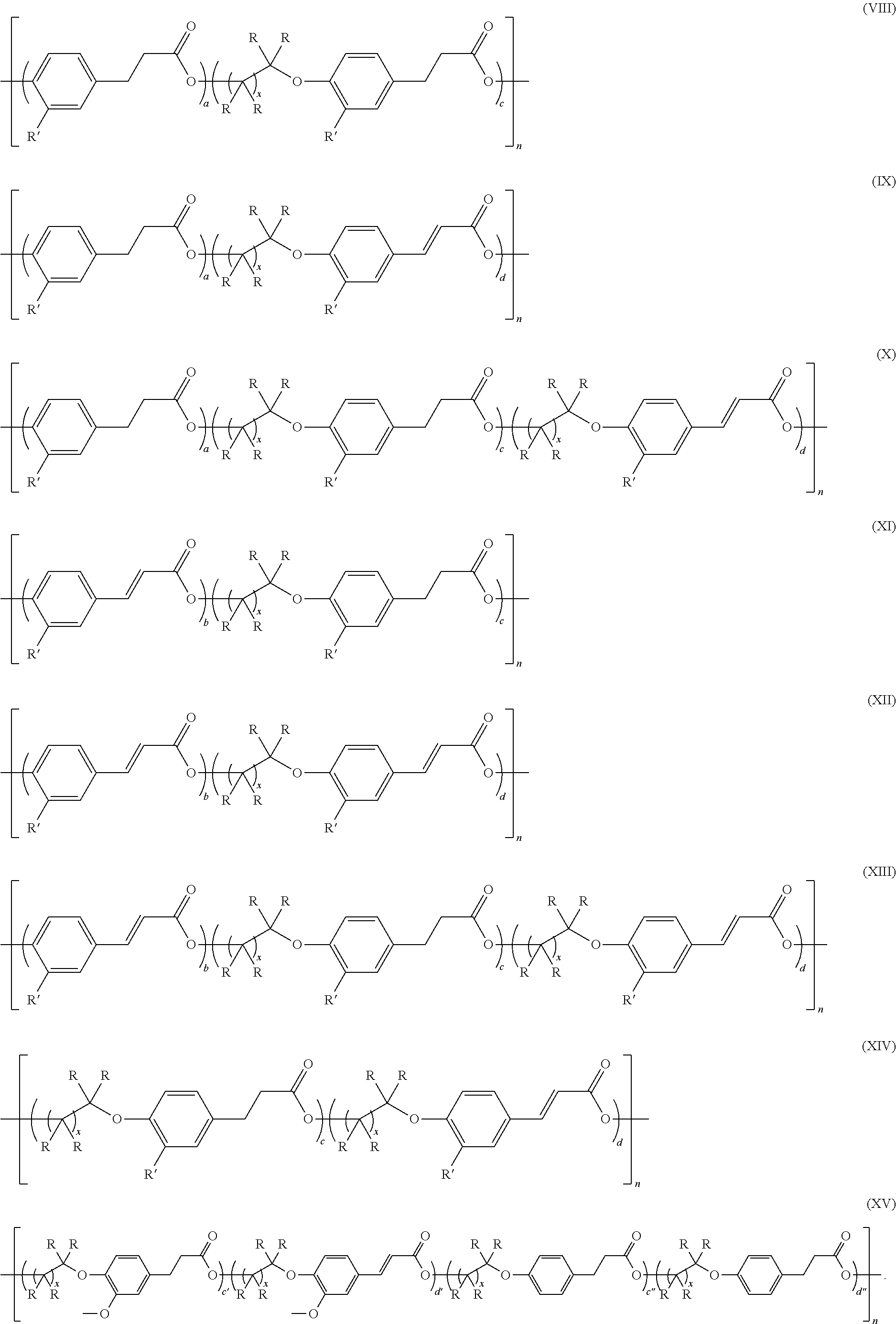

Polymers and copolymers, according to embodiments of the invention, are formed by direct polycondensation from hydroxyalkyldihydroferulic acid, for example, from the melt using Sb₂O₃ as catalyst to yield macromolecules with high molecular weight. These molecular weights are greater than those demonstrated in polyester synthesis using N,N-dicyclohexylcarbodiimide (DCC) or triazabicyclodecene (TBD) as catalyst. As indicated in

Table 1, below, indicates thermal behavior depending on the nature and size of the alkylene units for polymers according to embodiment of the invention with the structure V or VI, which can be considered as species from the copolymer XIV where a and b equals 0 and c or d equal 0. Table 1 shows that for R=H, the values of x, the aromatic substitution, and the unsaturation or saturation of the alpha and beta carbons in the cinnamic acid portion of the repeating units affects the thermal properties of the polymer. In like manner, the true copolymers of XIV show similar effects in true copolymer structures, as given in Table 2, according to an embodiment of the invention. Table 3 gives copolymer results where R′ is different for c repeating units and d repeating units.

TABLE 1
Homopolymer XIV for all R = H.^{a}

| | | % | Mn | Mw | | | | T |
|---|---|---|---|---|---|---|---|---|
| Entry | x, c, d, R′ | yield | (Da)^{b} | (Da)^{b} | PDI^{b} | Tg^{c} | Tm^{c} | 50%^{d} |
| 1 | 1, 0, 1, | 89.6 | 1,600 | 2,500 | 1.6 | 113 | | 536 |
| | MeO | | | | | | | |
| 2 | 1, 0, 1, | 87.1 | 22,100 | 79,400 | 3.6 | 32 | | 394 |
| | MeO | | | | | | | |
| 3 | 1, 0, 1, H | 85.9 | ^{e} | ^{e} | ^{e} | 109 | | 433 |
| 4 | 1, 1, 0, | 90.5 | 22,900 | 63,400 | 2.8 | 24 | 123 | 415 |
| | MeO | | | | | | | |
| 5 | 2, 0, 1, | 93.1 | 7,700 | 13,700 | 1.8 | 82 | | 405 |
| | MeO | | | | | | | |
| 6 | 5, 0, 1, | 92.7 | 10,000 | 26,600 | 2.6 | 51 | | 397 |
| | MeO | | | | | | | |

^{a}1 mol % Sb₂O₃; mixture melted under argon for 5 hours; 8 hour temperature ramp from 150 to 250° C. with dynamic vacuum.
^{b}Obtained by GPC in hexafluoroisopropanol (HFIP) at 40° C. versus polymethyl methacrylate (PMMA) standards.
^{c}Determined by DSC in ° C.,
^{d}Temperature in ° C. at which 50% mass loss is observed under nitrogen.
^{e}insoluble.

TABLE 2
Copolymer XIV for various fractions of c of
c + d with x = 1 and all R = H.^{a}

| | | % | | | | | |
|---|---|---|---|---|---|---|---|
| Entry | Frac c, R′ | yield | Mn (Da)^{b} | Mw (Da)^{b} | PDI^{b} | Tg^{c} | T 50%^{d} |
| 1 | 1.0, MeO | 87.1 | 22,100 | 79,400 | 3.6 | 32 | 394 |
| 2 | 0.9, MeO | 91.7 | 39,000 | 228,700 | 5.9 | 37 | 388 |
| 3 | 0.8, MeO | 88.4 | 26,500 | 81,100 | 3.1 | 41 | 389 |
| 4 | 0.7, MeO | 89.5 | 22,800 | 60,400 | 2.7 | 46 | 385 |
| 5 | 0.6, MeO | 90.9 | 12,900 | 25,000 | 1.9 | 52 | 386 |
| 6 | 0.5, MeO | 90.9 | 5,700 | 16,900 | 3.0 | 58 | 392 |
| 7 | 0.4, MeO | 76.4 | 5,900 | 11,100 | 1.9 | 66 | 389 |
| 8 | 0.3, MeO | 82.5 | 3,400 | 6,400 | 1.9 | 77 | 396 |
| 9 | 0.2, MeO | 89.9 | 3,200 | 6,000 | 1.9 | 87 | 414 |
| 10 | 0.1, MeO | 90.6 | 1,900 | 2,900 | 1.5 | 98 | 441 |
| 11 | 0, MeO | 89.6 | 1,600 | 2,500 | 1.6 | 113 | 356 |
| 12 | 1.0, H | 90.5 | 22,900 | 63,400 | 2.8 | 24 | 415 |
| 13 | 0.9, H | 92.2 | 29,400 | 134,500 | 4.6 | 29 | 415 |
| 14 | 0.5, H | 94.1 | 10,900 | 40,500 | 3.7 | 56 | 418 |
| 15 | 0.1, H | 87.3 | ^{e} | ^{e} | ^{e} | 94 | 430 |
| 16 | 0, H | 85.9 | ^{e} | ^{e} | ^{e} | 109 | 433 |

^{a}1 mol % Sb₂O₃; mixture was melted under argon for 5 hours; 8 hour temperature ramp from 150 to 250° C. with dynamic vacuum.
^{b}Obtained by GPC in hexafluoroisopropanol (HFIP) at 40° C. versus polymethyl methacrylate (PMMA) standards.
^{c}Determined by DSC.
^{c}Calculated using the Fox equation.
^{d}Temperature at which 50% mass loss is observed under nitrogen.
^{e}Insolubility of the polymers prevented GPC analysis.

TABLE 3
Copolymers XV for various fractions of c′, c″,
d′ and d″ with x = 1 and all R = H^{a}

| Entry | Frac c′, c″, d′, d″ | % yield | Mn (Da)^{b} | Mw (Da)^{b} | PDI^{b} | Tg^{c} |
|---|---|---|---|---|---|---|
| 1 | 0.8, 0, 0, 0.2 | 93.1 | 27,800 | 111,200 | 4.0 | 42 |
| 2 | 0.2, 0, 0, 0.8 | 89.9 | 2,800 | 7,800 | 2.8 | 79 |
| 3 | 0, 0.8, 0.2, 0 | 95.0 | 47,900 | 182,000 | 3.8 | 36 |
| 4 | 0, 0.2, 0.8, 0 | 94.0 | 1,800 | 3,800 | 2.1 | 92 |
| 5 | 0.5, 0,5, 0, 0 | 95.1 | 49,700 | 169,000 | 3.4 | 30 |
| 6 | 0.8, 0.2, 0, 0 | 94.4 | 37,600 | 176,700 | 4.7 | 32 |
| 7 | 0, 0, 0.5, 0.5 | 80.5 | n.o. | n.o. | n.o. | 126 |

^{a}1 mol % Sb₂O₃; mixture was melted under argon for 5 hours; 8 hour temperature ramp from 150 to 250° C. with dynamic vacuum;
^{b}by GPC in hexafluoroisopropanol (HFIP) at 40° C. versus polymethyl methacrylate (PMMA) standards;
^{c}Determined by DSC;
n.o. not observed.

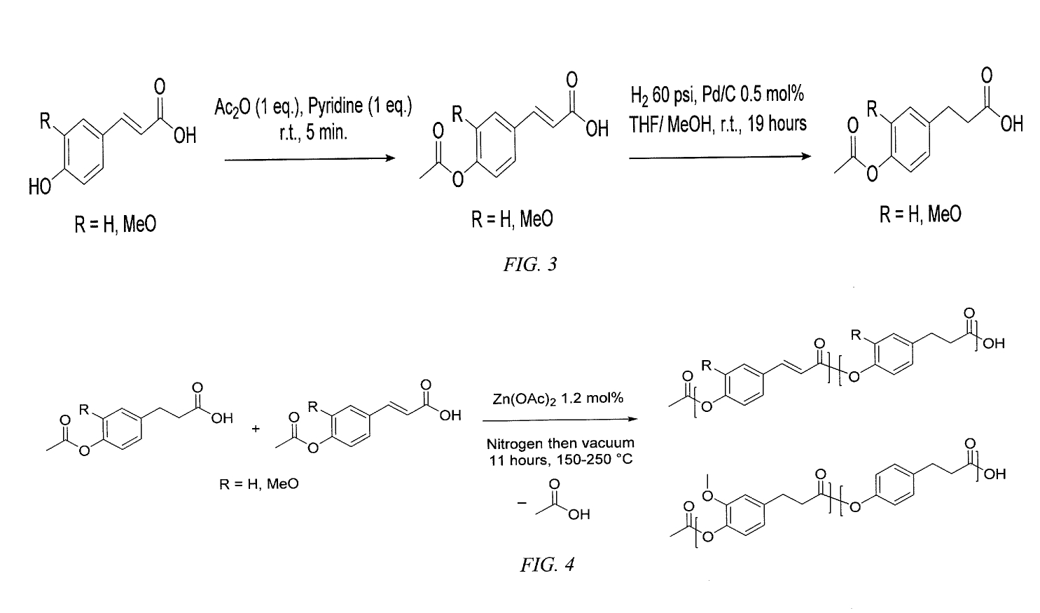

The properties of copolymers IV are given in: Table 4 for a′=0, a″>0, b′>0, b″=0; Table 5 for a′>0, a″=0, b′=0, b″>0; Table 6 for a′>0, a″>0, b′=0, b″=0; and Table 7 for a′=0, a″>0, b′=0, b″>0. Where acetyl containing monomers, whose synthesis is shown in FIG. 3, were combined with 1.2 mol % Zn(OAc)₂ and melted; a gradual temperature increase from 150 to 230° C. over 5 h under argon followed by dynamic vacuum at 230° C. for 6.5 h resulted in polymerization, as shown in FIG. 4.

TABLE 4
Polymerization results for poly(ferulic acid-co-dihydrocoumaric acid)

| | | | | | Tₘ^{c} | T_{50%}^{d} | M_{w}^{e} | Mₙ^{e} | |
|---|---|---|---|---|---|---|---|---|---|
| Entry | frac b′^{a} | Yield (%) | frac b′^{b} | T_{g}^{c} (° C.) | (° C.) | (° C.) | (Da) | (Da) | PDI^{e} |
| 1 | 0 | 91.1 | 0 | 82 | 219 | 455 | 15,300 | 6,600 | 2.3 |
| 2 | 0.1 | 83.7 | 0.5 | 72 | 224 | 399 | 7,900 | 2,600 | 3.1 |
| 3 | 0.2 | 77.7 | 0.13 | 76 | 213 | 413 | 10,400 | 3,200 | 3.2 |
| 4 | 0.3 | 73.4 | 0.20 | 78 | 214 | 417 | 6,300 | 2,000 | 3.2 |
| 5 | 0.4 | 67.6 | 0.30 | 81 | 182 | 417 | 6,800 | 2,000 | 3.3 |
| 6 | 0.5 | 67.4 | 0.20 | 88 | n.o. | 419 | 12,400 | 2,400 | 5.3 |
| 7 | 0.6 | 57.3 | 0.52 | 96 | n.o. | 420 | 22,100 | 3,000 | 7.4 |
| 8 | 0.7 | 61.7 | 0.60 | 114 | n.o. | 423 | 22,900 | 2,700 | 8.4 |
| 9 | 0.8 | 72.1 | 0.72 | 132 | n.o. | 434 | 18,800 | 2,100 | 8.8 |
| 10 | 0.9 | 60.0 | 0.85 | 141 | n.o. | 438 | 25,800 | 2,300 | 11.3 |
| 11 | 1.0 | 73.5 | 1.00 | 153 | n.o. | 459 | 13,000 | 2,800 | 3.9 |

^{a}Fraction of monomer in polymerization mixture;
^{b}Incorporation in the copolymers determined by ¹H NMR;
^{c}T_{g} and Tₘ determined by DSC;
^{d}Temperature at which 50% mass loss is observed under nitrogen;
^{e}Mₙ, M_{w} and polydispersity index (PDI) obtained by GPC in hexafluoroisopropanol (HFIP) at room temperature versus poly(methyl methacrylate) (PMMA) as standard.
n.o.: not observed.

TABLE 5
Polymerization results for poly(dihydroferulic acid-co-coumaric acid)

| | (frac | Yield | (frac | T_{g}^{c} | Tₘ^{c} | T_{50%}^{d} | M_{w}^{e} | Mₙ^{e} | |
|---|---|---|---|---|---|---|---|---|---|
| Entry | b″)^{a} | (%) | b″)^{b} | (° C.) | (° C.) | (° C.) | (Da) | (Da) | PDI^{e} |
| 1 | 0 | 85.6 | 0 | 78 | 243 | 408 | 9,400 | 3,400 | 2.8 |
| 2 | 0.1 | 80.7 | 0.06 | 77 | 223 | 410 | 26,100 | 5,400 | 4.9 |
| 3 | 0.2 | 75.6 | 0.14 | 82 | 204 | 413 | 32,400 | 5,300 | 6.2 |
| 4 | 0.3 | 77.4 | 0.25 | 87 | 192 | 418 | 47,900 | 5,100 | 9.4 |
| 5 | 0.4 | 77.7 | 0.27 | 87 | 182 | 421 | 45,500 | 4,700 | 9.8 |
| 6 | 0.5 | 87.2 | 0.42 | 90 | 175 | 427 | 66,100 | 4,500 | 14.7 |
| 7 | 0.6 | 87.0 | 0.47 | 94 | 262 | 437 | 43,900 | 3,900 | 11.4 |
| 8 | 0.7 | 82.3 | 0.51 | 110 | n.o. | 441 | 8,700 | 2,100 | 4.1 |
| 9 | 0.8 | 82.0 | 0.58 | 111 | n.o. | 456 | 3,200 | 1,300 | 2.5 |
| 10 | 0.9 | 85.6 | ^{f} | 129 | n.o. | 534 | ^{f} | ^{f} | ^{f} |
| 11 | 1.0 | 85.0 | 1.00 | n.o. | n.o. | 630 | ^{f} | ^{f} | ^{f} |

^{a}Fraction of monomer in polymerization mixture;
^{b}Incorporation in the copolymers determined by ¹H NMR;
^{c}T_{g} and Tₘ determined by DSC;
^{d}Temperature at which 50% mass loss is observed under nitrogen;
^{e}Mₙ, M_{w} and polydispersity index (PDI) obtained by GPC in hexafluoroisopropanol (HFIP) at room temperature versus poly(methyl methacrylate) (PMMA) as standard;
^{f}Insolubility of the polymers prevented GPC analysis;
n.o.: not observed.

TABLE 6
Polymerization results for poly(dihydroferulic acid-co-dihydrocoumaric acid)

| | | | | | Tₘ^{c} | T_{50%}^{d} | M_{w}^{e} | Mₙ^{e} | |
|---|---|---|---|---|---|---|---|---|---|
| Entry | (frac a″)^{a} | Yield (%) | (frac a″)^{b} | T_{g}^{c} (° C.) | (° C.) | (° C.) | (Da) | (Da) | PDI^{e} |
| 1 | 0 | 85.6 | 0 | 78 | 243 | 408 | 9,400 | 3,400 | 2.8 |
| 2 | 0.1 | 86.5 | 0.10 | 75 | 234 | 410 | 9,700 | 4,000 | 2.5 |
| 3 | 0.2 | 80.6 | 0.18 | 73 | 222 | 404 | 9,100 | 3,400 | 2.7 |
| 4 | 0.3 | 78.2 | 0.26 | 72 | 206 | 409 | 6,800 | 3,000 | 2.3 |
| 5 | 0.4 | 77.4 | 0.36 | 70 | 193 | 408 | 11,000 | 4,600 | 2.4 |
| 6 | 0.5 | 82.0 | 0.47 | 67 | 194 | 416 | 13,200 | 3,700 | 3.5 |
| 7 | 0.6 | 73.9 | 0.57 | 68 | 194 | 420 | 11,800 | 3,700 | 3.2 |
| 8 | 0.7 | 65.6 | 0.68 | 74 | 263 | 421 | 9,500 | 3,300 | 2.9 |
| 9 | 0.8 | 73.4 | 0.81 | 80 | 169 | 424 | 11,600 | 4,100 | 2.8 |
| 10 | 0.9 | 86.1 | 0.87 | 85 | 189 | 425 | 10,800 | 4,500 | 2.4 |
| 11 | 1.0 | 91.1 | 1.00 | 82 | 219 | 455 | 15,300 | 6,600 | 2.3 |

^{a}Fraction of monomer in polymerization mixture; then dynamic vacuum at 230° C. for 6.5 h.
^{b}Fraction of dihydrocoumaric acid (ADHCA) repeating units in the copolymers determined by ¹H NMR.
^{c}T_{g} and Tₘ determined by DSC.
^{d}Temperature at which 50% mass loss is observed under nitrogen.
^{e}Mₙ, M_{w} and polydispersity index (PDI) obtained by GPC in hexafluoroisopropanol (HFIP) at room temperature versus poly(methyl methacrylate) (PMMA) as standard

TABLE 7
Polymerization results for poly(coumaric
acid-co-dihydrocoumaric acid)

| | | Yield | T_{g}^{c} | Tₘ^{c} | T_{50%}^{d} | M_{w}^{e} | Mₙ^{e} | |
|---|---|---|---|---|---|---|---|---|
| Entry | (frac b″)^{a} | (%) | (° C.) | (° C.) | (° C.) | (Da) | (Da) | PDI^{e} |
| 1 | 0 | 91.1 | 82 | 216 | 455 | 15,300 | 6,600 | 2.3 |
| 2 | 10 | 93.8 | 73 | 219 | 445 | ^{e} | ^{e} | ^{e} |
| 3 | 20 | 85.9 | 76 | 209 | 449 | 8,500 | 2,800 | 3.2 |
| 4 | 30 | 89.9 | 86 | n.o. | 449 | 6,000 | 2,600 | 2.3 |
| 5 | 40 | 84.1 | 90 | n.o. | 456 | 7,600 | 2,900 | 2.7 |
| 6 | 50 | 83.2 | 115 | n.o. | 492 | 5,600 | 2,500 | 2.3 |
| 7 | 60 | 79.2 | 128 | n.o. | 504 | 3,300 | 2,100 | 1.6 |
| 8 | 70 | 85.2 | 132 | n.o. | 516 | ^{e} | ^{e} | ^{e} |
| 9 | 80 | 85.1 | 164 | n.o. | 577 | ^{e} | ^{e} | ^{e} |
| 10 | 90 | 83.3 | 177 | n.o. | 634 | ^{e} | ^{e} | ^{e} |
| 11 | 100 | 85.0 | n.o. | n.o. | 630 | ^{e} | ^{e} | ^{e} |

^{a}Fraction of monomer in polymerization mixture;
^{b}T_{g} and Tₘ determined by DSC.
^{c}Temperature at which 50% mass loss is observed under nitrogen.
^{d}Mₙ, M_{w} and polydispersity index (PDI) obtained by GPC in hexafluoroisopropanol (HFIP) at room temperature versus poly(methyl methacrylate) (PMMA) as standard.
^{e}Insolubility of the polymers prevented GPC analysis.
n.o.: not observed.

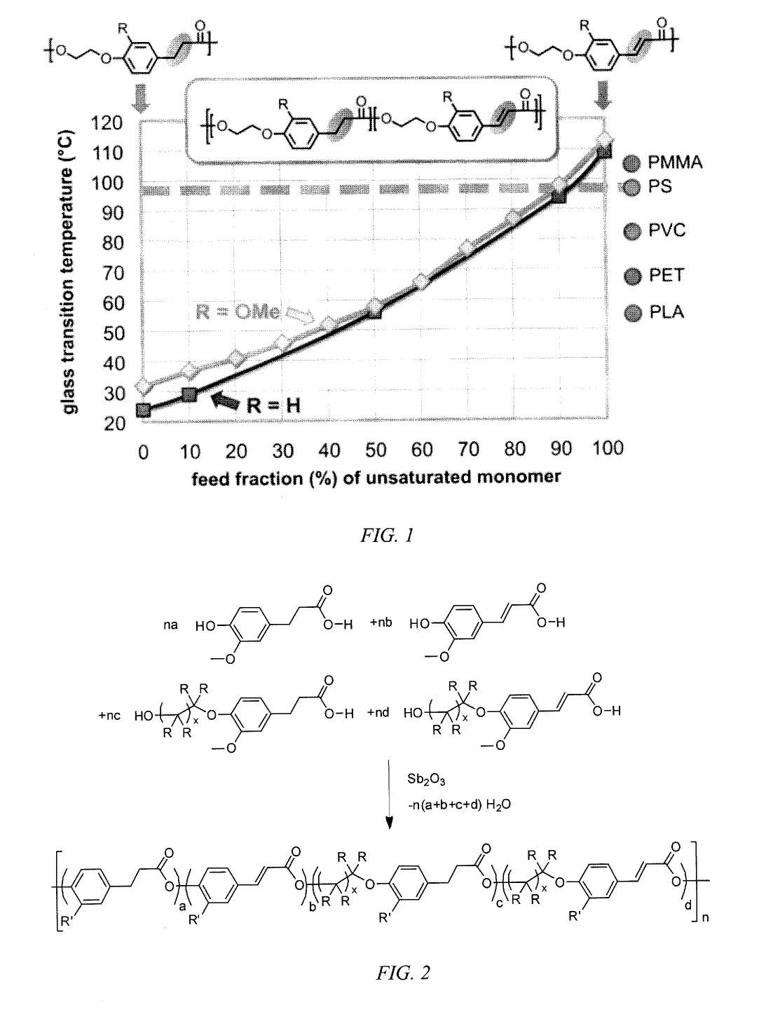

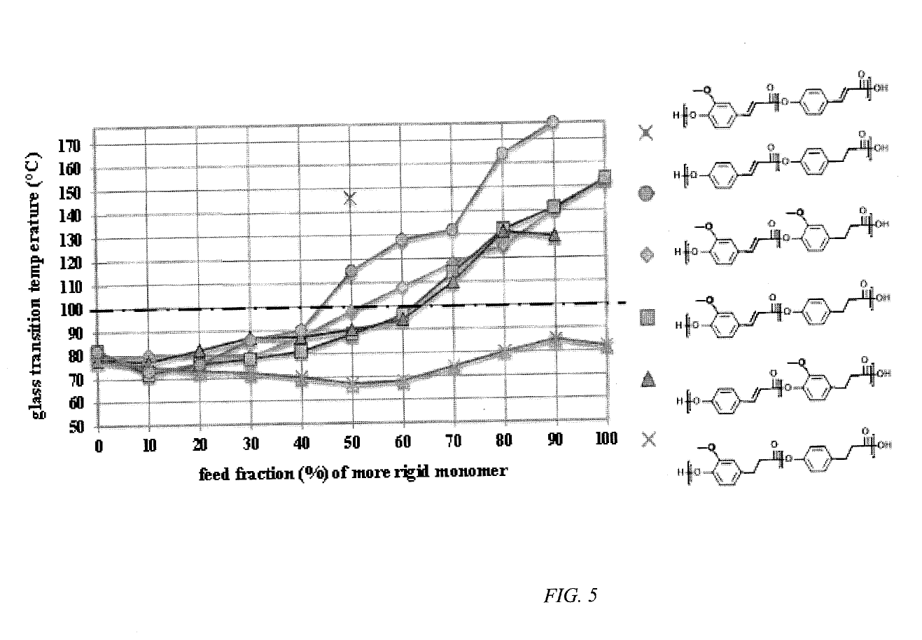

The ability to mimic the thermal properties of various commodity thermoplastics by control of the copolymer composition is shown in FIGS. 1 and 5. The T_{g} range of these two copolymers of FIG. 1, according to embodiments of the invention, spans the T_{g} values of several common commodity plastics, from polylactic acid (PLA, 55° C.) to polyethylene terephthalate (PET, 67° C.) to polyvinyl chloride (PVC, 82° C.) to polystyrene (PS, 95-100° C.) to polymethyl methacrylate (PMMA, 105° C.). In like manner, FIG. 5 shows that a wide range of T_{g}'s are possible by copolymerization.

In an embodiment of the invention, the polymers and copolymers according to embodiments of the invention are prepared by melt condensation of the monomer mixture in the presence of an esterification catalyst. The esterification catalyst can be a metal oxide, metal alkoxide, or metal acetate. The mole fraction of any given monomer in a copolymerization, according to an embodiment of the invention can be 0.01 to 0.99. The catalyst can be Sb₂O₃, as used in exemplary embodiments. Other catalysts that can be used, though not limited to, include: Mg(OCOCH₃)₂; Mn(OCOCH₃)₂; Zn(OCOCH₃)₂; Sn[OCO(C₂H₅)CH(CH₂)CH₃]₂; Sb(OCOCH₃)₃; Ti(OC₄H₉)₄; Zr(OC₄H₉)₄; GeO₂; TiO₂; PbO, MgO, any combination thereof or any combination thereof with Sb₂O₃. Other metal oxides, metal acetates, metal carbonates and metal alkoxides can be employed as catalyst. The catalyst can be used at levels of 1 mole percent or less; for example, the catalyst can be employed at 0.001 mole %, 0.01 mole %, 0.02 mole %, 0.05 mole %, 0.1 mole %, 0.2 mole %, 0.5 mole %, or 1 mole %. The catalyst can be added in a single charge or can be added in a series of two, three, or more charges. For example, a charge of catalyst can be added with the monomers and the condensation carried out without applying a vacuum for the removal of water. A second charge of the same or a different catalyst can then be added and vacuum applied. The polycondensation can be carried out over a range of temperatures and can be carried out with an ascending temperature during polycondensation, where the initial temperature is at least 100° C. and the final temperature is up to 285° C.

### METHODS AND MATERIALS

Via alibaba.com, ferulic acid (99%) was purchased from Xian Erica Botanical Products Co. or from Nanjing Zelang Medical Technology Co. and p-coumaric acid (99%) was purchased from Nanjing Zelang Medical Technology Co.; 2-chloroethanol and 3-chloropropanol were purchased from Acros Organics; and 6-chlorohexanol was purchased from Alfa Aesar. These were all utilized without further purification. NMR solvents, including deuterated chloroform (CDCl₃), deuterated dimethyl sulfoxide (DMSO-d₆), and deuterated trifluoroacetic acid (TFA-d) were purchased from Cambridge Isotope Laboratories. All other chemicals, unless expressly mentioned, were used as received.

Proton and carbon nuclear magnetic resonance (¹H and ¹³C NMR) spectra were recorded using an Inova 500 MHz spectrometer. Chemical shifts are reported in parts per million (ppm) downfield relative to tetramethylsilane (TMS, 0.0 ppm) or residual proton and carbon in the specified solvent. Coupling constants (J) are reported in Hertz (Hz).

Differential scanning calorimetry (DSC) thermograms were obtained with a DSC Q1000 from TA instruments. About 3-5 mg of each sample were massed and added to a sealed pan that passed through a heat/cool/heat cycle at 10° C./min. Reported data are from the second full cycle. The temperature ranged from −80 to 300° C., depending on the samples.

Thermogravimetric analyses (TGA) were measured under nitrogen with a TGA Q5000 from TA Instruments. About 5-10 mg of each sample was heated at 20° C./min from 25 to 600° C.

Gel permeation chromatography (GPC) was performed at 40° C. using an Agilent Technologies 1260 Infinity Series liquid chromatography system with an internal differential refractive index detector, and a PL HFIPgel column (4.6 mm i.d., 250 mm length) using a solution of 0.1% potassium triflate (K(OTf)) in HPLC grade hexafluoroisopropanol (HFIP, purchased from SynQuest Laboratories, Alachua, Fla.) as the mobile phase at a flow rate of 0.5 mL min. Calibration was performed with narrow polydispersity polymethyl methacrylate (PMMA) standards.

Monomer Preparation

Hydroxyethylferulic Acid

Ferulic acid (25.0 g (0.129 mol) was dissolved in a mixture of 11.9 g (0.297 mol) of sodium hydroxide and 3.35 g (0.022 mol) of sodium iodide in 268 mL of water. The mixture was refluxed at 85° C. until all solids had dissolved and 2-chloroethanol (12.6 mL (0.185 mol)) was slowly added. After one hour the temperature was raised to 100° C. and the reaction was refluxed for 4 days. The dark brown mixture was then hot vacuum filtered and cooled to room temperature. The filtrate was extracted with diethyl ether and acidified with concentrated hydrochloric acid until the product precipitated. The product was isolated using gravity filtration, dried in air, and triturated in ethanol. Dry white powder (22.8 g) was obtained in a 74.5% yield. ¹H NMR (DMSO-d₆): δ ppm 3.72 (t, J=4.7 Hz, 2H), 3.81 (s, 3H), 4.01 (t, J=5.0 Hz, 2H), 4.90 (br. s., 1H), 6.44 (d, J=15.9 Hz, 1H), 6.98 (d, J=8.4 Hz, 1H), 7.17 (d, J=8.2 Hz, 1H), 7.30 (s, 1H), 7.52 (d, J=15.9 Hz, 1H), 12.20 (br. s., 1H). ¹³C NMR (DMSO-d6): δ ppm 55.5, 59.4, 70.1, 110.5, 112.6, 116.7, 122.6, 127.1, 144.1, 149.1, 150.2, 167.9.

Hydroxyethyldihydroferulic Acid

Hydroxyethylferulic acid (23.0 g (0.097 mol) and 2.26 g (0.002 mol) of Pd/C (10 wt. % Pd) catalyst were mixed in 78 mL of methanol and 145 mL of THF. The mixture was hydrogenated at 60 psi for 4 hours and vacuum filtered through a layer of Celite. The filtrate was dried by a rotary evaporator and dissolved in THF. The product was then precipitated in cold hexane and isolated by gravity filtration. After drying under vacuum, 15.5 g of white solid were obtained in a 66.9% yield. ¹NMR (CDCl3): δ ppm 2.67 (t, J=7.6 Hz, 2H), 2.92 (t, J=7.6 Hz, 2H), 3.83 (s, 3H), 3.92 (t, J=4.6 Hz, 2H), 4.12 (t, J=4.5 Hz, 2H), 6.75 (d, J=7.7 Hz, 1H), 6.76 (s, 1H), 6.87 (d, J=7.8 Hz, 1H). ¹³C NMR (DMSO-d₆): δ ppm 30.0, 35.6, 55.4, 59.6, 70.3, 112.4, 113.3, 112.0, 133.5, 146.4, 148.8, 173.9.

Hydroxyethylcoumaric Acid

p-Coumaric acid (20.0 g (0.122 mol)) was dissolved in a mixture of 11.3 g (0.281 mol) of sodium hydroxide and 3.17 g (0.0207 mol) of sodium iodide in 250 mL of water. The mixture was refluxed at 85° C. until all solids dissolved and 11.9 mL (0.175 mol) of 2-chloroethanol was slowly added. After one hour, the temperature was raised to 100° C. and the reaction was refluxed for 64 hours. The dark brown mixture was then hot vacuum filtered and let cool to room temperature. The filtrate was extracted with diethyl ether and acidified with concentrated hydrochloric acid until the product precipitated. The product was isolated by gravity filtration, dried in air, and triturated in ethanol to yield 15.6 g of dry white powder in a 61.8% yield. ¹H NMR (DMSO-d6): δ ppm 3.60-3.83 (m, 2H), 4.03 (t, J=4.9 Hz, 2H), 4.89 (br. s., 1H), 6.37 (d, J=16.0 Hz, 1H), 6.97 (d, J=8.7 Hz, 2H), 7.54 (d, J=15.8 Hz, 1H), 7.62 (d, J=8.7 Hz, 2H), 12.20 (br. s., 1H). ¹³C NMR (DMSO-d6): δ ppm 59.5, 69.7, 114.8, 116.4, 126.7, 129.9, 143.7, 160.4, 167.8.

Hydroxyethyldihydrocoumaric Acid

Hydroxyethylcoumaric acid (6.5 g (0.031 mol)) and 1.8 g (0.00016 mol) of Pd/C (10 wt. % Pd) catalyst were mixed in 25 mL of MeOH and 47 mL of THF. The mixture was hydrogenated at 60 psi for 14 hours, and vacuum filtered through a layer of Celite. A rotary evaporator was used to remove a majority of the solvent, and the filtrate was cooled slowly to crystallize overnight. The crystals were gravity filtered and washed with cold hexanes. After drying under vacuum, 6.3 g of colorless to white crystals were obtained in a 96.3% yield. ¹H NMR (DMSO-d₆): δ ppm 2.48 (t, J=7.4 Hz, 2H) 2.74 (t, J=7.6 Hz, 2H), 3.69 (t, J=5.0 Hz, 2H), 3.93 (t, J=5.0 Hz, 2H), 6.83 (d, J=8.57 Hz, 2H), 7.12 (d, J=8.41 Hz, 2H), 12.06 (br. s., 1H). ¹³C NMR (DMSO-d₆): δ ppm 29.5, 35.6, 59.6, 69.4, 114.3, 129.2, 132.7, 157.0, 173.8.

Hydroxypropylferulic Acid

Ferulic acid (15.0 g (0.077 mol)) was dissolved in a mixture of 7.14 g (0.174 mol) of sodium hydroxide and 2.01 g (0.0131 mol) of sodium iodide in 158 mL of water. The mixture was refluxed at 85° C. until all solids had dissolved and 9.5 mL (0.11 mol) of 3-chloropropanol were slowly added. After one hour, the temperature was raised to 100° C. and the reaction was allowed to reflux for 67 hours. The dark brown mixture was then hot vacuum filtered and let cool to room temperature. The filtrate was extracted with diethyl ether and acidified with concentrated hydrochloric acid until the product precipitated. The product was isolated by gravity filtration, dried in the air, and triturated in ethanol. 13.0 g of dry white powder were obtained in a 71.6% yield. ¹H NMR (DMSO-d₆): δ ppm 1.86 (quin, J=6.2 Hz, 2H), 3.55 (t, J=6.0 Hz, 2H), 3.80 (s, 3H), 4.05 (t, J=6.3 Hz, 2H), 4.56 (br. s., 1 H), 6.43 (d, J=16.0 Hz, 1H), 6.96 (d, J=8.4 Hz, 1H), 7.18 (d, J=8.4 Hz, 1H), 7.30 (s, 1H), 7.52 (d, J=16.0 Hz, 1H), 12.21 (br. s., 1H). ¹³C NMR (DMSO-d₆): δ ppm 32.1, 55.6, 57.3, 65.3, 110.5, 112.4, 116.6, 122.7, 127.0, 144.2, 149.1, 150.2, 168.0.

Hydroxyhexylferulic Acid

Ferulic acid (20.0 g (0.103 mol)) was dissolved in a mixture of 9.52 g (0.238 mol) of sodium hydroxide and 2.68 g (0.018 mol) of sodium iodide in 214 mL of water. The mixture was refluxed at 85° C. until all solids had dissolved. At that point 20.5 mL (0.148 mol) of 6-chlorohexanol were slowly added. After one hour the temperature was raised to 100° C. and the reaction was allowed to reflux for 3 days. The dark brown mixture was then hot vacuum filtered and let cool to room temperature. The filtrate was extracted with diethyl ether and acidified with concentrated hydrochloric acid until the product precipitated. The product was isolated by gravity filtration, dried in air, and recrystallized in ethanol to yield 19.2 g of dry white powder in a 63.4% yield. ¹H NMR (CDCl₃): δ ppm 1.41-1.56 (m, 4H), 1.62 (quin, J=7.0 Hz, 2H), 1.89 (quin, J=7.0 Hz, 2H), 3.68 (d, J=6.5 Hz, 2H), 3.91 (s, 3H), 4.07 (d, J=6.7 Hz, 2H), 6.32 (d, J=15.8 Hz, 1H), 6.88 (d, J=8.2 Hz, 1H), 7.08 (d, J=1.7 Hz, 1H), 7.12 (dd, J1=8.4 Hz, J2=1.9 Hz, 1H), 7.73 (d, J=15.9 Hz, 1H). ¹³C NMR (DMSO-d₆): δ ppm 25.2, 25.4, 28.7, 32.5, 55.6, 60.6, 68.1, 110.5, 112.5, 116.6, 122.6, 126.9, 144.1, 149.1, 150.2, 167.9.

Acetyl Ferulic Acid.

To an Erlenmeyer flask of 1 L containing 200 g (1.03 mol) of ferulic acid was added slowly 97.184 mL (1.03 mol) of acetic anhydride under mechanical stirring, followed by 83 mL (1.03 mol) of pyridine. This dissolved the white suspension into a yellow liquid. After only 5 minutes of stirring, a cream colored solid was formed exothermally. After the mixture was cooled down, it was ground up and added to 2 L of water and left to stir overnight. The next day the mixture was gravity filtered and rinsed with more water. Once it had dried, it was ground up with a mortar and pestle and added to a round bottom flask for trituration. The product was triturated with THF in a ratio of 1 g product to 3 mL of THF. It was then vacuum filtered and washed twice with diethyl ether. After drying, the white powder was obtained with 90% yield (219 g).

Acetylcoumaric Acid.

To an Erlenmeyer flask of 1 L containing 200 g (1.218 mol) of coumaric acid was added slowly 124.37 g (1.218 mol) of acetic anhydride under mechanical stirring, followed by 98.2 mL (1.218 mol) of pyridine. This dissolved the white suspension into a yellow liquid. After only 5 minutes of stirring, a cream colored solid was formed exothermally. After the mixture was cooled down, it was ground up and added to 2 L of water and left to stir overnight. The next day the mixture was gravity filtered and rinsed with more water. Once it had dried, it was ground up with a mortar and pestle and added to a round bottom flask for trituration. The product was triturated with THF in a ratio of 1 g product to 2 mL of THF. It was then vacuum filtered and washed twice with diethyl ether. After drying, the white powder was obtained with 80% yield (201 g).

Acetyldihydroferulic Acid.

A 1.5 L high pressure flask was charged with 80 g (0.339 mol) of acetylferulic acid, 1.8 g (0.0017 mol) of 10% wt. Pd/C catalyst, 272 mL of MeOH and 509 mL of THF. The flask was purged with hydrogen gas at 60 psi. After 19 hours, the reaction was stopped and the product was vacuum filtered on celite. The filtrate was reduced to a minimum volume of solvent, about 30 mL, using an evaporator rotation. It was then allowed to cool and crystallize overnight. The crystals were gravity filtered and washed with cold hexanes. 77.4 g of a colorless crystal product was obtained with a yield of 96%.

Acetyldihydrocoumaric Acid.

A 1.5 L high pressure flask was charged with 48 g (0.233 mol) of acetylferulic acid, 1.24 g (0.0016 mol) of 10% wt. Pd/C catalyst, 187 mL of MeOH and 350 mL of THF. The flask was purged with hydrogen gas at 60 psi. After 17 hours, the reaction was stopped and the product was vacuum filtered on celite. The filtrate was reduced to a minimum volume of solvent, about 20 mL, using an evaporator rotation. It was then allowed to cool and crystallize overnight. The crystals were gravity filtered and washed with cold hexanes. 46.5 g of a colorless crystal product was obtained with a yield of 96%.

Polymerizations

Polymerization Apparatus

Polymerizations were typically conducted in a round bottom flask, connected to a rotary evaporation bump trap, connected to a vacuum line. With this apparatus, the by-product of condensation could be collected and seen in the bump trap. At the same time, all volatiles could be removed without changing the initial glassware configuration. All polymerizations were performed in the dark by covering the outside of the apparatus in aluminum foil.

General Work-Up Procedure for Non-Acetyl Monomer Condensation Polymerizations

Polyethylene dihydrocoumarate and polyethylene dihydroferulate were dissolved in a mixture of 3 mL tetrachloroethane and 7 mL chloroform. The polymer was precipitated from solution by pouring the polymer solution into 170 mL of cold methanol. The polymer was isolated by filtration and the polymer was washed with methanol. The polymer was dried under vacuum overnight. All other polymers were melted to remove them from the flask and used without further purification.

General NMR Preparation

Polyethylene dihydroferulate and polyethylene dihydro coumarate were prepared in chloroform-d. Polyethylene ferulate was prepared in DMSO-d6 for 13C NMR and in chloroform-d for 1H NMR. All other polymer samples were prepared in a combination of chloroform-d and trifluoroacetic acid-d. Even after heating and sonication, the polymers were only partially soluble in the NMR solvents.

Polyethylene Ferulate (PEF)

Table 1, Entry 1 and Table 2, Entry 11.

A 50 mL round bottom flask was charged with 1.00 g (4.2 mmol) of hydroxyethylferulic acid and 12 mg (1 mol %) of Sb₂O₃. The mixture was melted under an argon atmosphere gradually from 200 to 250° C. over a period of 4 hours. The system was placed under dynamic vacuum to remove the volatile condensation product. The system was kept under vacuum for 6 hours before cooling. Once cool, the aforementioned work-up procedure was applied to give the polymer in 89.6% yield (828 mg). ¹H NMR (CDCl₃/TFA-d): δ ppm 3.93 (m, 3H), 4.38 (m, 2H), 4.63 (m, 2H), 6.40 (d, J=16.0 Hz, 1H), 6.95 (m, 1H), 7.12 (m, 2H), 7.70 (d, J=15.7 Hz, 1H). ¹³C NMR (DMSO-d₆/TFA-d): δ ppm 56.1, 59.2, 67.2, 111.2, 113.4, 115.9, 123.4, 127.8, 134.5, 145.5, 150.4, 166.9.

Polyethylene Dihydroferulate

Table 1, Entry 2 and Table 2, Entry 1.

A 50 mL round bottom flask was charged with 1.00 g (4.2 mmol) of hydroxyethyldihydroferulic acid and 12 mg (1 mol %) of Sb₂O₃. The mixture was melted under an argon atmosphere gradually from 150 to 200° C. over a period of 4 hours. The system was placed under dynamic vacuum to remove volatile condensation products. The system was kept under vacuum for 8 hours before cooling. Once cool, the aforementioned work-up procedure was applied to give the polymer in 87.1% yield (806 mg). ¹H NMR (CDCl₃): δ ppm 2.65 (t, J=7.8, 2H), 2.90 (t, J=7.8, 2H), 3.83 (s, 3H), 4.18 (t, J=4.8, 2H), 4.42 (t, J=4.7, 2H), 6.72 (dd, J1=8.1 Hz, J2=1.8 Hz, 1H), 6.75 (d, J=1.7 Hz, 1H), 6.80 (d, J=8.1 Hz, 1H). ¹³C NMR (CDCl₃): δ ppm 30.5, 35.9, 55.9, 62.9, 67.4, 112.4, 114.7, 120.2, 134.4, 146.3, 149.7, 172.8.

Polyethylene Coumarate (PEC)

Table 1, Entry 3 and Table 2, Entry 16.

A 50 mL round bottom flask was charged with 1.50 g (7.2 mmol) of hydroxyethylcoumaric acid and 21 mg (1 mol %) of Sb₂O₃. The mixture was melted under an argon atmosphere gradually from 200 to 250° C. over a period of 4 hours. The system was placed under dynamic vacuum to remove the volatile condensation product. The system was kept under vacuum for 6 hours before cooling. Once cool, the aforementioned work-up procedure was applied to give the polymer in 85.9% yield (1.18 g). ¹H NMR (CDCl₃/TFA-d): δ ppm 4.30 (br. s., 2H), 4.60 (br. s., 2H), 6.38 (d, J=16.2 Hz, 1H), 6.95 (d, J=8.0 Hz, 2H) 7.50 (d, J=8.2 Hz, 2H), 7.71 (d, J=15.9 Hz, 1H). ¹³C NMR (CDCl₃/TFA-d): δ ppm 63.3, 66.0, 114.4, 115.0, 127.2, 130.2, 146.4, 160.4, 168.8.

Polyethylene Dihydrocoumarate

Table 1, Entry 4 and Table 2, Entry 12.

A 50 mL round bottom flask was charged with 1.50 g (7.1 mmol) of hydroxyethyldihydrocoumaric acid and 21 mg (1 mol %) of Sb₂O₃. The mixture was melted under an argon atmosphere gradually from 150 to 200° C. over a period of 4 hours. The system was placed under dynamic vacuum to remove volatile condensation product. The system was kept under vacuum for 8 hours before cooling. Once cool, the aforementioned work-up procedure was applied to give the polymer in 90.5% yield (1.24 g). ¹H NMR (CDCl₃): δ ppm 2.65 (t, J=7.8, 2H), 2.90 (t, J=7.8, 2H), 4.09 (t, J=4.7, 2H), 4.40 (t, J=4.7, 2H), 6.80 (d, J=8.7 Hz, 2H), 7.11 (d, J=8.5 Hz, 2H). ¹³C NMR (CDCl₃): δ ppm 30.0, 36.0, 62.8, 65.9, 114.6, 129.3, 133.0, 156.9, 172.8.

Polypropylene Ferulate

Table 1, Entry 5.

A 50 mL round bottom flask was charged with 1.50 g (5.9 mmol) of hydroxypropylferulic acid and 17 mg (1 mol %) of Sb₂O₃. The mixture was melted under an argon atmosphere gradually from 180 to 220° C. over a period of 5 hours. The system was placed under dynamic vacuum to remove volatile condensation product. The system was kept under vacuum for 8 hours before cooling. Once cool, the aforementioned work-up procedure was applied to give the polymer in 93.1% yield (1.3 g). ¹H NMR (CDCl₃/TFA-d): δ ppm 2.28 (quin, J=6.2 Hz, 2H), 3.92 (s, 3H), 4.22 (t, J=6.0 Hz, 2H), 4.46 (t, J=6.2 Hz, 2H), 6.37 (d, J=15.9 Hz, 1H), 6.92 (d, J=8.4 Hz, 1H), 7.10 (m, 1H), 7.14 (d, J=8.1 Hz, 1H), 7.68 (d, J=15.9 Hz, 1H).). ¹³C NMR (CDCl₃/TFA-d): δ ppm: 28.4, 56.0, 62.1, 65.5, 110.5, 112.6, 114.9, 123.2, 127.4, 146.2, 149.3, 150.5, 169.0.

Polyhexalene Ferulate

Table 1, Entry 6.

A 50 mL round bottom flask was charged with 1.50 g (5.1 mmol) of hydroxyhexylferulic acid and 13 mg (1 mol %) of Sb₂O₃. The mixture was melted under an argon atmosphere gradually from 155 to 200° C. over a period of 5 hours. The system was placed under dynamic vacuum to remove volatile condensation product. The system was kept under vacuum for 8 hours before cooling. Once cool, the aforementioned work-up procedure was applied to give the polymer in 92.7% yield (1.31 g). ¹H NMR (CDCl₃/TFA-d): δ ppm 1.40-163 (m, 4H), 1.77 (quin, J=6.9 Hz, 2H), 1.88 (quin, J=6.7 Hz, 2H), 3.93 (s, 3H), 4.09 (t, J=6.7 Hz, 2H), 4.27 (t, J=6.7 Hz, 2H), 6.37 (d, J=15.9 Hz, 1H), 6.89 (d, J=8.5 Hz, 1H), 7.10 (s, 1H), 7.14 (d, J=8.2 Hz, 1H), 7.68 (d, J=15.9 Hz, 1H). ¹³C NMR (CDCl₃/TFA-d): δ ppm 25.57, 25.64, 28.4, 28.7, 56.1, 65.8, 69.0, 110.6, 112.4, 115.5, 123.5, 127.0, 146.5, 148.8, 150.7, 170.0.

Copolymers of Hydroxyethyldihydroferulic Acid and Hydroxyethylferulic Acid

Copoly(Hydroxyethyldihydroferulic Acid/Hydroxyethylferulic Acid) [90:10]

Table 2, Entry 2.

A 50 mL round bottom flask was charged with 908 mg (3.8 mmol) of hydroxyethyldihydroferulic acid, 100 mg (0.4 mmol) of hydroxyethylferulic acid and 12 mg (1 mol %) of Sb₂O₃. The mixture was melted under an argon atmosphere gradually from 160 to 200° C. over a period of 4 hours. The system was placed under dynamic vacuum to remove volatile condensation product. The system was kept under vacuum for 8 hours before cooling. Once cool, the aforementioned work-up procedure was applied to give the polymer in 91.7% yield (855 mg). ¹³C NMR (CDCl3/TFA-d): δ ppm major peaks: 30.4, 36.0, 55.87, 63.4, 67.3, 112.5, 114.2, 120.7, 134.3, 145.8, 148.9, 174.8; minor peaks: 55.93, 63.2, 66.9, 110.7, 113.1, 115.0, 123.1, 128.0, 134.7, 146.5, 150.0.

Copoly(Hydroxyethyldihydroferulic Acid/Hydroxyethylferulic Acid) [80:20]

Table 1, Entry 3.

This polymer was synthesized using the same procedure as for copoly(hydroxyethyl-dihydroferulic acid/hydroxyethylferulic acid) [90:10]. 807 mg (3.4 mmol) of hydroxyethyldihydroferulic acid, 200 mg (0.8 mmol) of hydroxyethylferulic acid and 12 mg (1 mol %) of Sb₂O₃ were used. The product was obtained in 88.4% yield (823 mg). ¹³C NMR (CDCl₃/TFA-d): δ ppm major peaks: 30.4, 36.0, 55.85, 63.3, 67.3, 112.5, 114.3, 120.6, 134.3, 145.9, 149.1, 174.3; minor peaks: 55.91, 63.1, 66.9, 110.6, 113.2, 114.4, 123.0, 128.0, 134.2, 146.2, 149.4, 174.2.

Copoly(Hydroxyethyldihydroferulic Acid/Hydroxyethylferulic Acid) [70:30]

Table 1, Entry 4.

This polymer was synthesized using the same procedure as for copoly(hydroxyethyl-dihydroferulic acid/hydroxyethylferulic acid) [90:10]. 706 mg (2.9 mmol) of hydroxyethyldihydroferulic acid, 300 mg (1.3 mmol) of hydroxyethylferulic acid and 12 mg (1 mol %) of Sb₂O₃ were used. The product was obtained in 89.5% yield (832 mg). ¹³C NMR (CDCl₃/TFA-d): δ ppm major peaks: 30.3, 36.0, 55.9, 63.6, 67.3, 112.6, 114.1, 120.9, 134.2, 145.7, 148.7, 175.4; minor peaks: 56.0, 63.3, 66.9, 110.8, 113.02, 114.9, 123.3, 128.0, 134.7, 146.7, 149.9, 175.1.

Copoly(Hydroxyethyldihydroferulic Acid/Hydroxyethylferulic Acid) 160:401

Table 1, Entry 5.

This polymer was synthesized using the same procedure as for copoly(hydroxyethyl-dihydroferulic acid/hydroxyethylferulic acid) [90:10]. 605 mg (2.5 mmol) of hydroxyethyldihydroferulic acid, 400 mg (1.7 mmol) of hydroxyethylferulic acid and 12 mg (1 mol %) of Sb₂O₃ were used. The product was obtained in 90.9% yield (844 mg).

Copoly(Hydroxyethyldihydroferulic Acid/Hydroxyethylferulic Acid) [50:50]

Table 1, Entry 6.

A 50 mL round bottom flask was charged with 530 mg (2.2 mmol) of hydroxyethyldihydroferulic acid, 526 mg (2.2 mmol) of hydroxyethylferulic acid and 13 mg (1 mol %) of Sb₂O₃. The mixture was melted under an argon atmosphere gradually from 170 to 230° C. over a period of 4 hours. Afterwards the system was placed under dynamic vacuum to increase the degree of polymerization by removal of the volatile condensation product. The system was kept under vacuum for 8 hours before cooling. Once cool, the aforementioned work-up procedure was applied to give the polymer in 90.9% yield (888 mg). ¹H NMR (CDCl₃/TFA-d): δ ppm 2.60-2.75 (m, 2H), 2.81-3.01 (m, 2H), 3.67-3.86 (m, 3H), 3.87-4.03 (m, 3H), 4.08-4.88 (m, 8H), 6.38 (d, J=16.0 Hz, 1H), 6.50-7.21 (m, 6H), 7.66 (d, J=15.7 Hz, 1H).

Copoly(Hydroxyethyldihydroferulic Acid/Hydroxyethylferulic Acid) [40:60]

Table 1, Entry 7.

This polymer was synthesized using the same procedure as for copoly(hydroxyethyl-dihydroferulic acid/hydroxyethylferulic acid) [50:50]. 400 mg (1.7 mmol) of hydroxyethyldihydroferulic acid, 595 mg (2.5 mmol) of hydroxyethylferulic acid and 12 mg (1 mol %) of Sb₂O₃ were used. The product was obtained in 76.4% yield (703 mg).

Copoly(Hydroxyethyldihydroferulic Acid/Hydroxyethylferulic Acid) [30:70]

Table 1, Entry 8.

A 50 mL round bottom flask was charged with 300 mg (1.2 mmol) of hydroxyethyldihydroferulic acid, 694 mg (2.9 mmol) of hydroxyethylferulic acid and 12 mg (1 mol %) of Sb₂O₃. The mixture was melted under an argon atmosphere gradually from 180 to 240° C. over a period of 4 hours. The system was placed under dynamic vacuum to remove volatile condensation product. The system was kept under vacuum for 6.5 hours before cooling. Once cool, the aforementioned work-up procedure was applied to give the polymer in 82.5% yield (758 mg).

Copoly(Hydroxyethyldihydroferulic Acid/Hydroxyethylferulic Acid) [20:80]

Table 1, Entry 9.

A 50 mL round bottom flask was charged with 250 mg (1.04 mmol) of hydroxyethyldihydroferulic acid, 992 mg (4.2 mmol) of hydroxyethylferulic acid and 15 mg (1 mol %) of Sb₂O₃. The mixture was melted under an argon atmosphere gradually from 190 to 240° C. over a period of 3.5 hours. The system was placed under dynamic vacuum to remove volatile condensation product. The system was kept under vacuum for 6.5 hours before cooling. Once cool, the aforementioned work-up procedure was applied to give the polymer in 89.9% yield (1.03 g).

Copoly(Hydroxyethyldihydroferulic Acid/Hydroxyethylferulic Acid) [10:90]

Table 1, Entry 10.

A 50 mL round bottom flask was charged with 120 mg (0.5 mmol) of hydroxyethyl-dihydroferulic acid, 1.07 g (4.5 mmol) of hydroxyethylferulic acid and 15 mg (1 mol %) of Sb₂O₃. The mixture was melted under an argon atmosphere gradually from 200 to 250° C. over a period of 3.5 hours. The system was placed under dynamic vacuum to remove volatile condensation product. The system was kept under vacuum for 6.5 hours before cooling. Once cool, the aforementioned work-up procedure was applied to give the polymer in 90.6% yield (998 mg).

Copolymers of Hydroxyethyldihydrocoumaric Acid and Hydroxyethylcoumaric Acid

Copoly(Hydroxyethyldihydrocoumaric Acid/Hydroxyethylcoumaric Acid) [90:10]

Table 2, Entry 13.

A 50 mL round bottom flask was charged with 909 mg (4.3 mmol) of hydroxyethyldihydrocoumaric acid, 100 mg (0.5 mmol) of hydroxyethylcoumaric acid and 14 mg (1 mol %) of Sb₂O₃. The mixture was melted under an argon atmosphere gradually from 150 to 200° C. over a period of 5 hours. The system was placed under dynamic vacuum to remove volatile condensation product. The system was kept under vacuum for 8 hours before cooling. Once cool, the aforementioned work-up procedure was applied to give the polymer in 92.2% yield (851 mg). ¹³C NMR (CDCl₃/TFA-d): δ ppm major peaks: 30.0, 36.2, 63.8, 65.9, 114.9, 129.4, 132.8, 156.7, 175.5; minor peaks: 63.6, 66.1, 114.3, 115.0, 127.2, 130.3, 146.8, 160.6, 175.4.

Copoly(Hydroxyethyldihydrocoumaric Acid/Hydroxyethylcoumaric Acid) [50:50]

Table 2, Entry 14.

A 50 mL round bottom flask was charged with 606 mg (2.9 mmol) of hydroxyethyldihydrocoumaric acid, 600 mg (2.9 mmol) of hydroxyethylcoumaric acid and 17 mg (1 mol %) of Sb₂O₃. The mixture was melted under an argon atmosphere gradually from 160 to 220° C. over a period of 5 hours. The system was placed under dynamic vacuum to remove volatile condensation product. The system was kept under vacuum for 7 hours before cooling. Once cool, the aforementioned work-up procedure was applied to give the polymer in 94.1% yield (1.04 g). ¹H NMR (CDCl3/TFA-d): δ ppm 2.64-2.77 (m, 2H), 2.83-2.99 (m, 2H), 3.99-4.72 (m, 8H), 6.39 (d, J=16.0 Hz, 1H), 6.73-6.87 (m, 2H), 6.87-7.01 (m, 2H), 7.04-7.18 (m, 2H), 7.44-7.57 (m, 2H), 7.72 (d, J=15.9 Hz, 1H).

Copoly(Hydroxyethyldihydrocoumaric Acid/Hydroxyethylcoumaric Acid) [10:90]

Table 2, Entry 15.

A 50 mL round bottom flask was charged with 110 mg (0.5 mmol) of hydroxyethyldihydrocoumaric acid, 982 mg (4.7 mmol) of hydroxyethylcoumaric acid and 15 mg (1 mol %) of Sb₂O₃. The mixture was melted under an argon atmosphere gradually from 195 to 250° C. over a period of 4 hours. The system was placed under dynamic vacuum to remove volatile condensation product. The system was kept under vacuum for 7 hours before cooling. Once cool, the aforementioned work-up procedure was applied to give the polymer in 87.3% yield (871 mg).

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A cinnamic acid polymer or copolymer, comprising the structure: 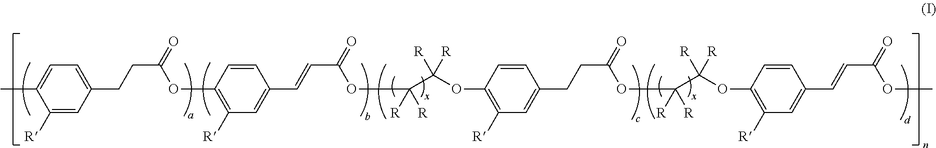
wherein R′ is H, OCH₃, or a mixture thereof; where —(CR₂)ₓCR₂— is C₂ to C₁₂, R is independently H or C₁ to C₈ alkyl, x is independently 1 to 11, a≥0, b≥0, c≥0, d≥0, n(a+b+c+d)≥40 and wherein:
when a>0 either c+d>0 or R′=a combination of H and OCH₃;
when b>0 either c+d>0 or R′=a combination of H and OCH₃;
when c>0 either a+b+d>0, R′=H or a combination of H and OCH₃, or —(CR₂)—CR₂— is C₃ to C₁₂ alkylene; or
when d>0, a+b+c>0.

2. The cinnamic acid polymer or copolymer according to claim 1, wherein the structure is: 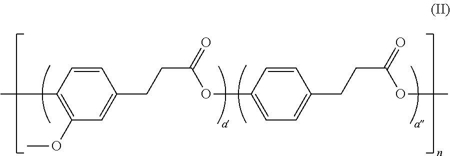
where a′>0, a″>0, and n(a′+a″)≥40.

3. The cinnamic acid polymer or copolymer according to claim 1, wherein the structure is: 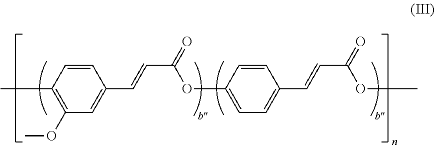
where b′>0, b″>0, and n(b′+b″)≥40.

4. The cinnamic acid polymer or copolymer according to claim 1, wherein the structure is: 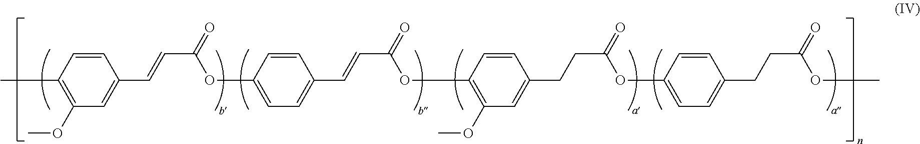
where a′>0, a″>0, b′>0, b″>0, and n(a′+a″+b′+b″)≥40.

5. The cinnamic acid polymer or copolymer according to claim 1, wherein the structure is: 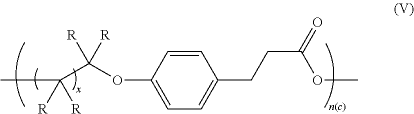
where n(c)≥40.

6. The cinnamic acid polymer or copolymer according to claim 1, wherein the structure is: 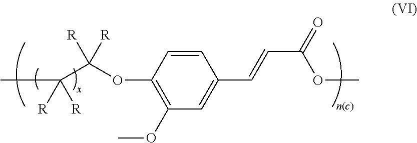
where n(c)≥40 and —(CR₂)ₓCR₂— is C₃ to C₁₂ alkylene.

7. The cinnamic acid polymer or copolymer according to claim 1, wherein the structure is: 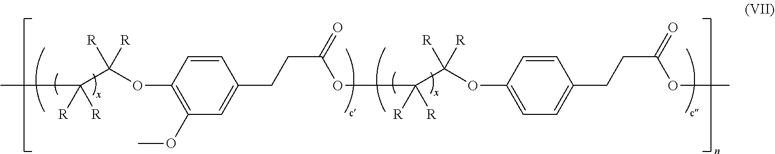
where c′>0, c″>0, and n(c′+c″)≥40.

8. The cinnamic acid polymer or copolymer according to claim 1, wherein the structure is:

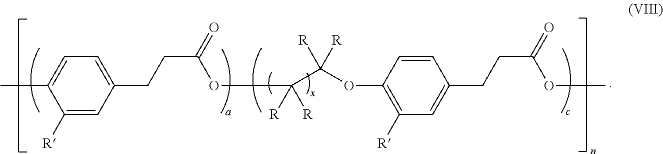

9. The cinnamic acid polymer or copolymer according to claim 1, wherein the structure is:

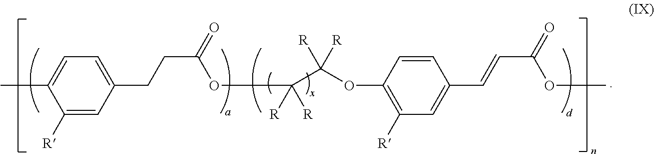

10. The cinnamic acid polymer or copolymer according to claim 1, wherein the structure is:

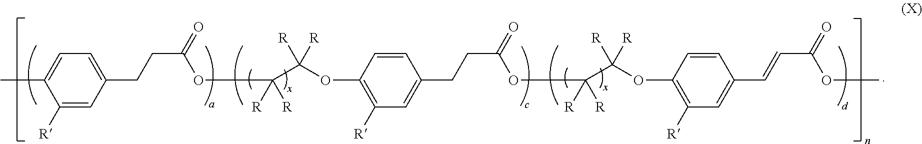

11. The cinnamic acid polymer or copolymer according to claim 1, wherein the structure is:

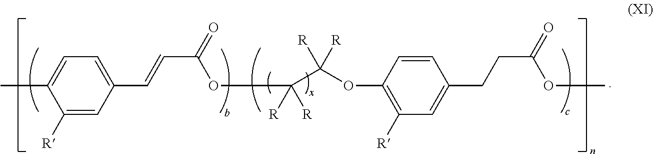

12. The cinnamic acid polymer or copolymer according to claim 1, wherein the structure is:

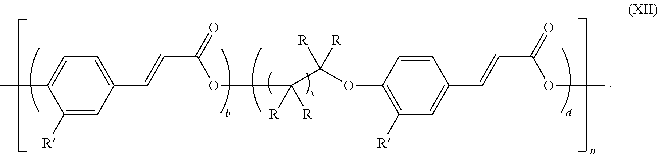

13. The cinnamic acid polymer or copolymer according to claim 1, wherein the structure is:

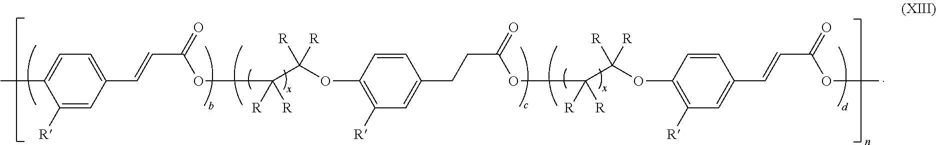

14. The cinnamic acid polymer or copolymer according to claim 1, wherein the structure is:

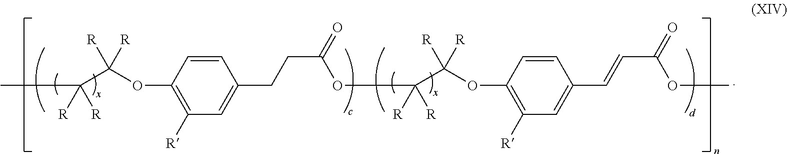

15. The cinnamic acid polymer or copolymer according to claim 1, wherein the structure is: 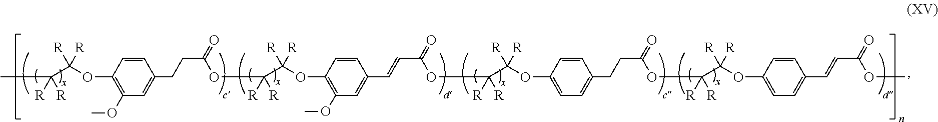
where c′>0, c″>0, d′>0, d″>0, and n(c′+c″+d′+d″)≥40.

16. A method of preparing a cinnamic acid polymer or polymer according to claim 1, comprising:
providing a plurality of monomers of at least two of: 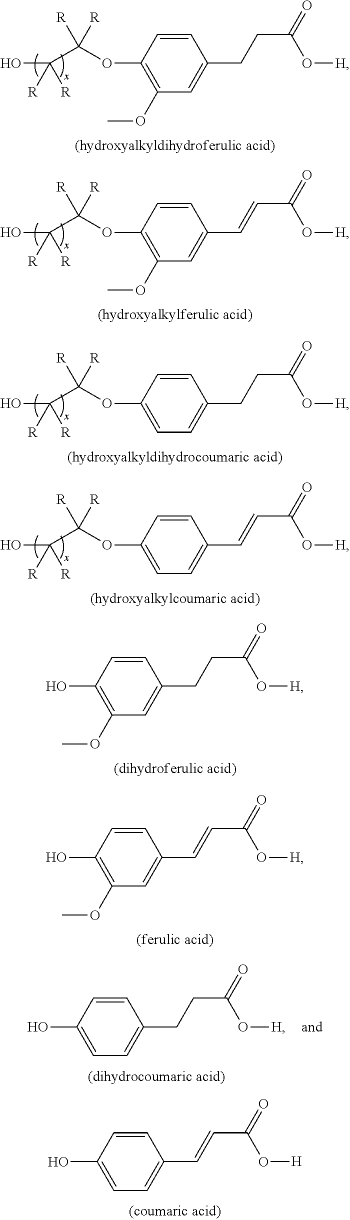
combining the plurality of monomers with a catalyst comprising a metal oxide, a metal alkoxide, or a metal acetate to form a polymerization mixture;
heating the polymerization mixture to a temperature above the glass transition temperature of a copolymer from the co-polymerization mixture;
removing water from the polymerization mixture; and
isolating the copolymer of the structure: 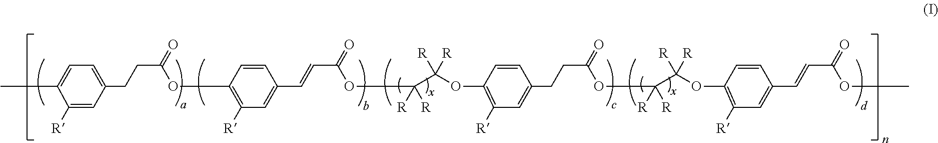
wherein R′ is H, OCH₃, or a mixture thereof; where —(CR₂)ₓCR₂— is C₂ to C₁₂, R is independently H or C₁ to C₈ alkyl, x is independently 1 to 11, a≥0, b≥0, c≥0, d≥0, n(a+b+c+d)≥40 and wherein:
when a>0 either c+d>0 or R′=a combination of H and OCH₃;
when b>0 either c+d>0 or R′=a combination of H and OCH₃;
when c>0 either a+b+d>0, R′=H or a combination of H and OCH₃, or —(CR₂)ₓCR₂— is C₃ to C₁₂ alkylene; or
when d>0, a+b+c>0.

17. The method of claim 16, wherein the catalyst is selected from: Sb₂O₃, Mg(OCOCH₃)₂; Mn(OCOCH₃)₂; Zn(OCOCH₃)₂; Sn[OCO(C₂H₅)CH(CH₂)CH₃]₂; Sb(OCOCH₃)₃; Ti(OC₄H₉)₄; Zr(OC₄H₉)₄; GeO₂; TiO₂; PbO; MgO; or any combination thereof.

18. A method of preparing a cinnamic acid copolymer according to claim 1, comprising:
providing a plurality of monomers of at least two of:
acetyl dihydroferulic acid, acetyl ferulic acid), acetyl dihydrocoumaric acid, and acetyl coumaric acid, wherein
when acetyl dihydroferulic acid is a first monomer, a second monomer is acetyl dihydrocoumaric acid or acetyl coumaric acid,
when acetyl dihydrocoumaric acid is a first monomer, a second monomer is acetyl-dihydroferulic acid or acetyl ferulic acid);
combining the plurality of monomers with a catalyst comprising a metal oxide, a metal alkoxide, or a metal acetate to form a copolymerization mixture;
heating the copolymerization mixture to a temperature above the glass transition temperature of a copolymer from the copolymerization mixture;
removing water from the copolymerization mixture; and
isolating the copolymer.

19. The method of claim 18, wherein the catalyst is selected from: Sb₂O₃; Mg(OCOCH₃)₂; Mn(OCOCH₃)₂; Zn(OCOCH₃)₂; Sn[OCO(C₂H₅)CH(CH₂)CH₃]₂; Sb(OCOCH₃)₃; Ti(OC₄H₉)₄; Zr(OC₄H₉)₄; GeO₂; TiO₂; PbO; MgO; or any combination thereof.

20. A method of preparing a cinnamic acid polymer according to claim 1, comprising:
providing a plurality of a hydroxyalkyldihydroferulic acid monomers and/or a hydroxyalkyldihydrocoumaric acid monomers of the structure: 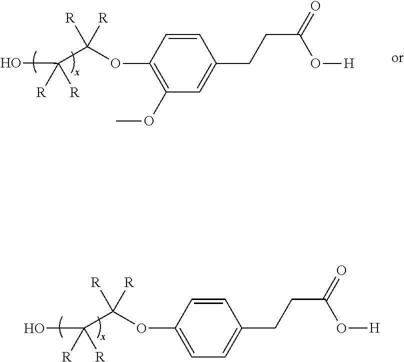
wherein —(CR₂)ₓCR₂— is at least one or C₂ to C₁₂ alkylene for the hydroxyalkyldihydrocoumaric acid monomer and —(CR₂)—CR₂— is at least one of C₃ to C₁₂ alkylene for hydroxyalkyldihydroferulic acid, R is independently H or C₁ to C₈ alkyl, and x is independently 1 to 11;
combining the plurality of the hydroxyalkyldihydroferulic acid monomer or the hydroxyalkyldihydrocoumaric acid monomer monomers with a catalyst comprising a metal oxide, a metal alkoxide, or a metal acetate to form a polymerization mixture;
heating the polymerization mixture to a temperature above the glass transition temperature of a polymer from the polymerization mixture;
removing water from the polymerization mixture; and
isolating the polymer.

21. The method of claim 20, wherein the catalyst is selected from: Sb₂O₃; Mg(OCOCH₃)₂; Mn(OCOCH₃)₂; Zn(OCOCH₃)₂; Sn[OCO(C₂H₅)CH(CH₂)CH₃]₂; Sb(OCOCH₃)₃; Ti(OC₄H₉)₄; Zr(OC₄H₉)₄; GeO₂; TiO₂; PbO; MgO; or any combination thereof.
